(19) United States
(12) Patent Application Publication
(10) Pub. No.: US 2005/0107122 A1
(43) Pub. Date: May 19, 2005

(54) Method for backing up data stored in a mobile phone

(76) Inventors: Ian Carel Van Reenen, Stellenbosch (ZA); Daniel Petrus Marais, Bellville (ZA); Jacobus Grobler, SomersetWest (ZA)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/493,417

(22) PCT Filed: Oct. 23, 2002
(86) PCT No.: PCT/IB02/04390

(30) Foreign Application Priority Data
Oct. 23, 2001 (GB) 0125451.5

(51) Int. Cl. H04M 1/00

(52) U.S. Cl. 455/558; 455/564; 455/556.1

(57) ABSTRACT

This invention relates to a method of backing up data in a mobile telephone, in which data is transmitted from the telephone device to a storage means via a telephone network. The invention extends to a telephone device having a transmitting means for transmitting data. The device is optionally provided with application software for controlling connection to a back up facility and the transfer of data to and from the back up storage means. The back up facility has a receiving data from the telephone device via the telephone network and a storage means.

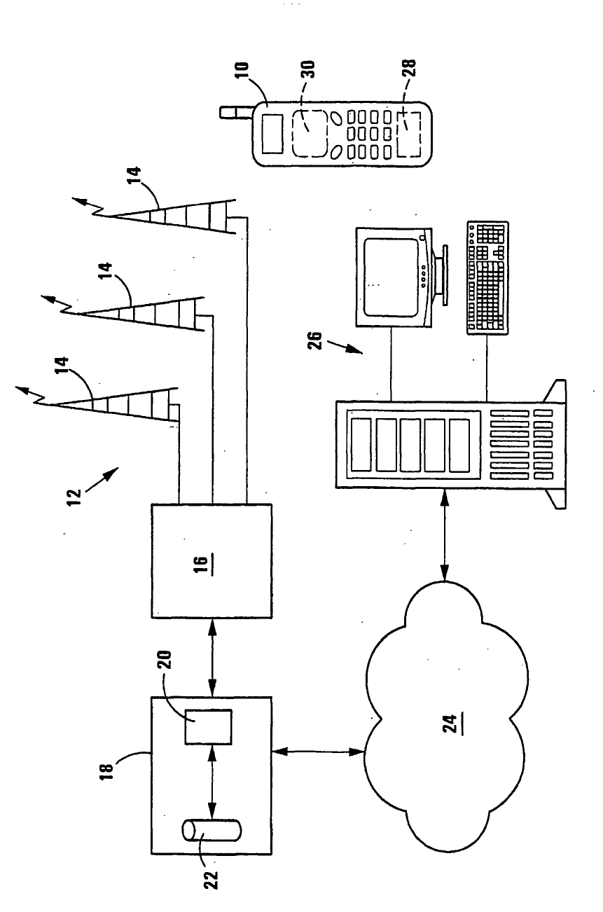

This invention relates to the backing up of data from mobile telephone devices and the restoration of data thereto.

According to a first aspect of the invention there is provided a method of backing up data in a mobile telephone device, which includes
transmitting data from the telephone device to a storage means via a telephone network.

Further according to the first aspect of the invention there is provided a telephone device which includes
a transmitting means for transmitting data in the telephone device to a back up storage means via a telephone network.

The device may be a personal digital assistant (PDA) with telephone connectivity.

The data may be resident in a memory module of the telephone device or in an auxiliary memory module, such as a SIM card, associated with the telephone device.

According to a second aspect of the invention there is provided a method of backing up data from a mobile telephone device, which includes
receiving data from the telephone device via a telephone network; and
storing the data on a back up storage means.

Further according to the second aspect of the invention there is provided a back up facility for backing up data from a mobile telephone device, which includes
a receiving means for receiving data from the telephone device via a telephone network; and
a storage means for storing the received data.

The data may be backed up automatically. This may be triggered by an initiating means in the telephone device or at the back up facility.

The invention extends to application software for the telephone device for controlling connection to the back up facility and the transfer of data to and from the back up storage means. The software may be supplied to the telephone device from the back up facility, also via the telephone network.

The telephone network may be a cellular network.

Data may be transferred to and from the telephone device by means of SMS, GPRS, GSM Data Call, or any other suitable way, depending on the type of network used. The software may be supplied to the telephone device in a similar manner. The software may also be downloaded via a wireless network, such as BlueTooth, or from the internet, or via infrared. The back up procedure may also be initiated from the back up facility by means of an SMS message, or the like.

Data may be transferred in an encrypted manner. Thus, the software may have encryption and de-cryption capability.

The telephone device may be a simple handset, or it may be more sophisticated and have other functionalities, such as a calendar function, an address book, word processing and spreadsheet capability, and the like. Similarly, the device may be a personal digital assistant with telephone connectivity.

Data that is backed up may be the names and telephone numbers stored in the telephone device, calendar data, addresses, files, notes, tasks, graphics, and the like.

It will be appreciated that the first time data is backed up, all the data in the telephone device will be transferred to the back up facility. Thereafter, if the telephone device has sufficient memory, the application software may be such that it identifies only changes that have been made to the data since the last back up and only the changes are transmitted to the back up facility, these changes being stored at the back up facility as patches. Instead, all the data may be transferred every time and the changes that have been made to the data since the previous back up may then be determined at the back up facility and the changes stored as patches. The bandwidth of the telephone network will also determine whether all the data is transmitted from the telephone device to the back up facility or only the changes.

A synchronizing facility may also be provided. The data stored at the back up facility may then be accessible via the telephone network from a different device, or in another way such as via the Internet, so that the data may be suitably modified. Conveniently, the data for several devices may be simultaneously varied by an authorized person.

The data stored on the back up storage means may also be accessed by an operator of the telephone network. Thus, data may be personalized and flagged in a value added manner. For example, telephone numbers associated with a subscriber account may be flagged as being business or personal numbers and accounts may then separate calls and their associated costs to the two groups.

The invention extends further to a mobile telephone device that has been programmed with the software as aforementioned. The software may be resident in the memory module of the telephone device or the SIM card used therewith.

The invention extends still further to a carrier which has the software described above thereon.

The invention will now be described, by way of an example, with reference to the accompanying drawing which illustrates the invention schematically.

Referring to the drawing, a GSM telephone handset 10 is shown. The handset 10 interacts with a cellular telephone network 12 which includes a number of cells 14 connected to a central exchange 16. Administration of the network and billing of subscribers is also performed at the exchange 16.

The exchange is also connected to a back up facility 18. The back up facility 18 has a controller 20 and a storage device 22. The back up facility 18, in turn, is connected to the Internet 24 via an ISP (not shown) or the like. A computer station 26, associated with the owner of the handset 10, is also connected to the Internet 24 via an ISP (also not shown).

The handset 10 has a SIM card 28 and a processor and internal memory 30. Data such as names and phone numbers is stored on the SIM card 28 and the memory 30. Other data, such as addresses, information associated with the stored names, appointments, notes, tasks, files, etc may also be stored in the internal memory 30, depending on the sophistication and functionality of the handset 10.

The SIM card 28 also has stored thereon application software to perform a back up operation to back up the data in the SIM card 28 and the internal memory 30 to the back up facility 18, via the telephone network 12. The application software is downloaded to the handset 10 via the telephone network from the back up facility 18. Thus, in operation, at regular intervals, the controller 20 of the back up facility 18 sends an SMS message to the handset 10 which initiates the back up procedure. On receipt of the initiating signal, the application software causes the handset 10 to call an appropriate number which connects the handset to the back up facility 18 via the network 12 and data is transmitted to the back up facility 18 and stored on the storage device 22. The data is transmitted in an encrypted form. As discussed above, depending on the size of the memory on the SIM card 28 and/or the internal memory 30, and the bandwidth of network 12, either all the data or only the changes that have taken place since the last download, are transmitted. If a user of the handset loses his data, he can upload it from the back up facility 18 via the network 12.

It will be appreciated that with a personal digital assistant having telephone connectivity or a more sophisticated handset 10, the application software to perform the back up operation may be stored in either the SIM card 28 or the internal memory 30 thereof.

The user of the handset 10 can also modify and access his data stored on the storage device 22 from the computer station 26, via the Internet 24. Clearly, this could be done from any location. The application software resident in the handset 10 may then also synchronize the data thereon with the data stored at the back up facility 18. If the handset 10 is used for business purposes, then the data stored in the back up facility 18 for a number of handsets 10 used by employees of the business could all be modified and updated by a supervisor. The supervisor, or the user, could also flag numbers to indicate if they are business or personal in nature. The network administrator could then access the data stored at the back up facility for each subscriber and personalize each subscribers account.

1. A method of backing up data in a mobile telephone device, which includes storing changes that have been made to the data in the telephone device since a previous back up, in a storage means as patches.

2. The method as claimed in claim 1, in which the data backed up is resident in a memory module of the telephone device.

3. The method as claimed in claim 1, in which the data backed up is resident in a SIM cards associated with the telephone device.

4. The method as claimed in claim 1, in which the changes that have been made to the data are transmitted from the telephone device to the storage means, via a telephone network.

5. The method as claimed in claim 1, in which the data is received, changes that have been made to the data since the previous back up are determined at the storage means and these changes are stored.

6. A telephone device which includes
a detecting means for detecting changes that have been made to data in the telephone device since a previous back up, and
a transmitting means for transmitting the changes to a storage means.

7. The telephone device as claimed in claim 6, in which the detecting means detects changes made to data resident in a memory module of the telephone device.

8. The telephone device as claimed in claim 6, in which the detecting means detects changes made to data resident in a SIM card associated with the telephone device.

9. The telephone device as claimed in claim 6, which has functionalities selected from the group consisting of a calendar function, an address book, word processing, spreadsheet capability, and graphics capability.

10. The telephone device as claimed in claim 6, which is a personal digital assistant with telephone connectivity.

11. Application software for a telephone device as claimed in claim 6, for controlling connection to a back up f the transfer of data to and from a back up storage means, which includes a change determining means for determining changes that have been made to the data since a previous back up and for transmitting only the changes to a back up storage means.

12. A back up facility for backing up data from a mobile telephone device via a telephone network, which includes
a receiving means for receiving data from the telephone device via a telephone network; and
a patch storing arrangement for storing changes that have been made to the data in the telephone device since a previous back up, as patches.

13. A method of backing data in a mobile telephone device, which includes receiving a back up initiating signal via a telephone network; and transmitting data to be backed up, in response to the initiating signal, to a back up storage means, via a telephone network.

14. A telephone device which includes
an initiating signal detecting means for detecting a back up initiating signal received, in use, via a telephone network, and
a transmitting means for transmitting data in the telephone device to a back up storage means via a telephone network, in response to an initiating signal detected by the detecting means.

15. A method of maintaining data in a mobile telephone device, which includes synchronising data in the telephone device with back up data stored in a back up facility that has been modified from a further device.

16. A telephone device which includes
a synchronising means for synchronising data in the telephone device with back up data stored in a back up facility that has been modified from a further device.

17. A back up facility for backing up data from a mobile telephone device, which includes
a receiving means for receiving data from the telephone device via a telephone network; and
a storage means for storing the received data characterised thereby that the storage means is accessible from a further device to modify the data stored in the storage device.
